(19) United States
(12) Patent Application Publication
(10) Pub. No.: US 2023/0220914 A1
(43) Pub. Date: Jul. 13, 2023

(54) GASKET

(71) Applicant: UCHIYAMA MANUFACTURING CORP., Okayama (JP)

(72) Inventor: Kazunori EDAHIRO, Okayama (JP)

(21) Appl. No.: 18/093,898

(22) Filed: Jan. 6, 2023

(30) Foreign Application Priority Data
Jan. 12, 2022 (JP) 2022-003356

(51) Int. Cl. F16J 15/06

(52) U.S. Cl. CPC F16J 15/067

(57) ABSTRACT

Provided is an annular gasket for sealing a gap between opposed surfaces of two members, the gasket including a core body including a plurality of split components, a sealing unit fixed to the core body, and an elastic member, in which: ends of the plurality of split components are mated together in such a manner as to have a gap between the ends; the ends mated together are joined by the elastic member; and edges of the joined ends are inclined relative to a longitudinal direction of the split components in plan view.

### CROSS-REFERENCE TO RELATED APPLICATION

This application claims priority from Japanese Patent Application No. 2022-003356 filed with the Japan Patent Office on Jan. 12, 2022, the entire content of which is hereby incorporated by reference.

### BACKGROUND

### 1. Technical Field

The present disclosure relates to an annular gasket that is used to seal a gap between opposed surfaces of two members.

### 2. Related Art

For example, an annular gasket is conventionally known which is interposed between opposed surfaces of a heat exchanger cover and a heat exchanger of, or between opposed surfaces of a cylinder block and an oil pan of, an internal combustion engine, and fastens the two members together to seal a gap between the opposed surfaces of the two members.

Annular gaskets disclosed in U.S. Pat. No. 5,618,047 and JP-A-2010-133477 are known. In the annular gaskets, ends of two split components that have been mated together are joined to form an annular shape. An elastic sealing layer is adhered integrally to the inner peripheral surface of the annular unit. In the gaskets of U.S. Pat. No. 5,618,047 and JP-A-2010-133477 above, the two split components that have been mated together form a joint portion. An elastic material that has been poured into the joint portion is cured. The two split components joined in this manner forms the annular unit.

In a general gasket manufacturing method, one metal sheet is stamped into an annular shape to obtain a whole annular unit. In this manufacturing method, the internal part of the annular unit is discarded as scrap in many cases. On the other hand, if a gasket includes an annular unit having a plurality of assembled split components as disclosed in U.S. Pat. No. 5,618,047 and JP-A-2010-133477 above, the plurality of split components can be stamped from one metal sheet in the manufacturing of the gasket. Hence, the amount of waste material produced from one metal sheet is reduced. As a result, production yield increases.

### SUMMARY

An annular gasket according to the present embodiment, for sealing a gap between opposed surfaces of two members, including: a core body including a plurality of split components; a sealing unit fixed to the core body; and an elastic member. In the gasket, ends of the plurality of split components are mated together in such a manner as to have a gap between the ends, the ends mated together are joined by the elastic member, and edges of the joined ends are inclined relative to a longitudinal direction of the split components in plan view.

### BRIEF DESCRIPTION OF DRAWINGS

FIG. 1A is a schematic plan view of a gasket according to one embodiment of the present disclosure;

FIG. 1B is a schematic enlarged view of part A of FIG. 1A;

FIG. 1C is a schematic enlarged view of part B of FIG. 1A;

FIG. 2A is a cross-sectional view along X-X′ in FIG. 1B;

FIG. 2B is a cross-sectional view along X-X′ in FIG. 1B of the gasket of FIG. 1A with a gap between opposed surfaces of two members sealed;

FIG. 3A is a schematic enlarged view illustrating a modification of part A of FIG. 1A;

FIG. 3B is a schematic enlarged view illustrating a modification of part C of FIG. 1A;

FIG. 4A is a schematic plan view of a gasket according to one modification; and

FIG. 4B is a schematic plan view of a gasket according to another modification.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, in the gaskets in U.S. Pat. No. 5,618,047 and JP-A-2010-133477 above, the joint portion is formed along a longitudinal direction of the split components, and a width direction perpendicular to the longitudinal direction. Hence, rigidity against bending in the longitudinal direction, or rigidity in the width direction may be insufficient.

Considering the above circumstances, a gasket according to the embodiment is provided. In other words, an object of the present disclosure is to provide an annular gasket including a plurality of split components that can improve flexural rigidity.

In order to achieve the above-described object, an annular gasket according to the present embodiment is an annular gasket for sealing a gap between opposed surfaces of two members, the gasket including: a core body including a plurality of split components; a sealing unit fixed to the core body; and an elastic member. In the gasket, ends of the plurality of split components are mated together in such a manner as to have a gap between the ends, the ends mated together are joined by the elastic member, and edges of the joined ends are inclined relative to a longitudinal direction of the split components in plan view.

The gasket according to the embodiment has the above-mentioned configuration. Hence, the gasket includes the plurality of split components that can improve flexural rigidity.

The embodiment is described hereinafter on the basis of the drawings. Part of the full reference numerals assigned in part of the drawings may be omitted in the other drawings.

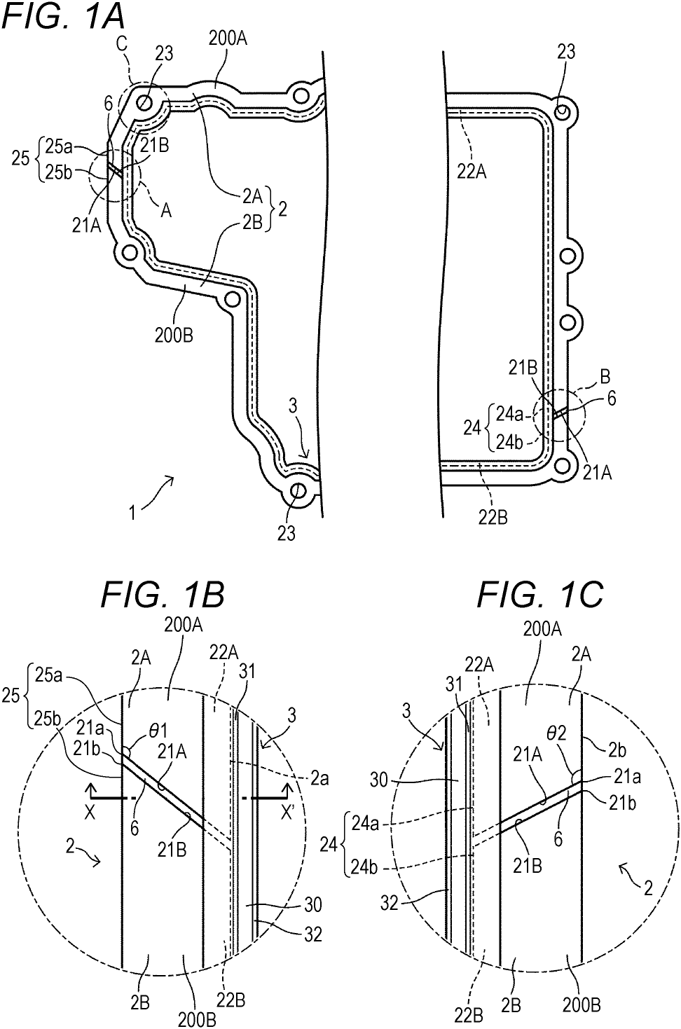

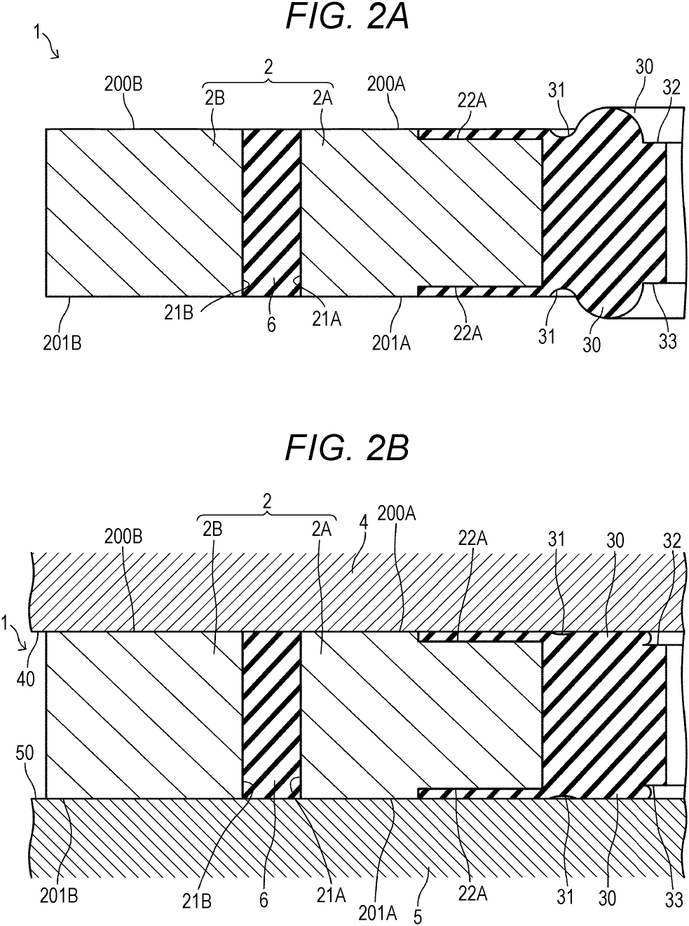

A gasket 1 according to the embodiment includes a core body 2 including a plurality of split components, a sealing unit 3 fixed to the core body 2, and an elastic member 6. The gasket is an annular gasket that seals a gap between opposed surfaces 40 and 50 (FIG. 2B) of two members. The configuration of the core body 2 is not particularly limited. The core body 2 is simply required to include the plurality of split components obtained by splitting the core body. The core body 2 of the gasket 1 illustrated in FIGS. 1A to 1C and FIGS. 2A and 2B includes a first split component 2A and a second split component 2B. In the core body 2, ends of the first split component 2A are mated to ends of the second split component 2B in such a manner as to have gaps respectively between the ends. First mating portions 21A and second mating portions 21B, which are configured in this manner, are joined together by the elastic member 6. As a result, the gasket 1 is formed into an annular shape. Furthermore, the gasket 1 includes the sealing unit 3. The sealing unit 3 is fixed to the core body 2, and is in an elastically deformed form. In this manner, the sealing unit 3 can seal the gap between the opposed surfaces 40 and 50 of the two members. An edge 21a of each of the first mating portions 21A is configured in such a manner as to be inclined relative to a longitudinal direction of the first split component 2A in plan view. Similarly, an edge 21b of each of the second mating portions 21B is configured in such a manner as to be inclined relative to a longitudinal direction of the second split component 2B in plan view.

A detailed description is given below with reference to the drawings.

As illustrated in FIG. 2B, the two members sealed by the gasket 1 placed between the opposed surfaces 40 and 50 are a first member 4 and a second member 5 in the embodiment. The first member 4 is placed in such a manner as to cover the second member 5 from above. Examples of the first member 4 and the second member 5 include a heat exchanger cover and a heat exchanger of, and a cylinder block and an oil pan of an internal combustion engine. The gasket 1 has a shape that fits the shape of the opposed surface 40 of the first member 4 and the shape of the opposed surface 50 of the second member 5 in plan view of the gasket 1 illustrated in FIG. 1A.

As described above, the gasket 1 includes the core body 2 formed into an annular shape, and the sealing unit 3 fixed to the core body 2. The core body 2 includes the two split components 2A and 2B, more specifically, the first split component 2A and the second split component 2B. The first split component 2A and the second split component 2B are mated together in such a manner as to have the gaps respectively between the ends of the first split component 2A in the longitudinal direction in plan view and the ends of the second split component 2B in the longitudinal direction in plan view. In the embodiment, the ends, in the longitudinal direction, of the first split component 2A that is mated in such a manner as to have the gaps are referred to as the first mating portions 21A. Moreover, the ends, in the longitudinal direction, of the second split component 2B, the ends facing the first mating portions 21A, are referred to as the second mating portions 21B. The elastic member 6 is poured into the gaps between the first mating portions 21A and the second mating portions 21B. The first mating portions 21A and the second mating portions 21B are bonded together by the vulcanized elastic member 6. As a result, the core body 2 is formed into an annular shape. Furthermore, the molded and vulcanized elastic member 6 allows the annular sealing unit 3 to be fixed to and formed integrally with an inner peripheral surface 24 of the core body 2. Hence, an inner peripheral surface 24a of the first split component 2A and an inner peripheral surface 24b of the second split component 2B form the inner peripheral surface 24 of the annular core body 2. Moreover, similarly, an outer peripheral surface 25a of the first split component 2A and an outer peripheral surface 25b of the second split component 2B form an outer peripheral surface 25 of the annular core body 2.

The first split component 2A and the second split component 2B are formed by stamping a rigid metal sheet such as a cold rolled steel sheet or a stainless steel sheet. One of the first mating portions 21A illustrated in part A of FIG. 1A and FIG. 1B, including the edge 21a, is inclined linearly relative to the longitudinal direction of the first split component 2A in plan view at an angle θ1 (hereinafter referred to as “angle of inclination” as appropriate) in such a manner as not to be parallel to and perpendicular to the longitudinal direction. One of the second mating portions 21B that faces the one of the first mating portions 21A via the gap, including the edge 21b, is formed with a predetermined angle of inclination in such a manner as to be substantially parallel to the one of the first mating portions 21A.

The other first mating portion 21A illustrated in FIG. 1C, including the edge 21a, is inclined linearly at an angle θ2 being a different angle from θ1 in such a manner as to intersect the longitudinal direction of the first split component 2A in plan view. The other first mating portion 21A faces the other second mating portion 21B via the gap. In addition, the other second mating portion 21B, including the edge 21b, is formed with a predetermined angle of inclination in such a manner as to be substantially parallel to the other first mating portion 21A.

The one of the first mating portions 21A and the one of the second mating portions 21B are formed in such a manner as to be inclined upward to the left in the page of FIGS. 1A and 1B. On the other hand, the other first mating portion 21A and the other second mating portion 21B are formed in such a manner as to be inclined upward to the right in the page of FIGS. 1A and 1C. In this manner, the one of the first mating portions 21A and the one of the second mating portions 21B, and the other first mating portion 21A and the other second mating portion 21B are formed in such a manner as to be inclined in the different directions from each other.

As illustrated in FIG. 2A, a stepped-down portion 22A is formed at one end of each of a top surface 200A and an undersurface 201A of the first split component 2A in a width direction of the first split component 2A in such a manner that the one end is cut inward in a thickness direction of the first split component 2A. Moreover, although not illustrated, a stepped-down portion 22B is also similarly formed at one end of each of a top surface 200B and an undersurface 201B of the second split component 2B in a width direction of the second split component 2B in such a manner that the one end is cut inward in a thickness direction of the second split component 2B. In the embodiment, the stepped-down portions 22A and 22B are provided on the inner peripheral surface 24 of the first split component 2A and the second split component 2B. Moreover, the first split component 2A and the second split component 2B are provided with a plurality of bolt holes 23 (FIG. 1A) for assembling the gasket 1 to the first member 4 and the second member 5 with bolts being fasteners.

In the embodiment, the first split component 2A and the second split component 2B are joined together by the elastic member 6 that is in the gaps of approximately one mm provided between the first mating portions 21A and the second mating portions 21B. Moreover, as illustrated in FIGS. 1B and 1C, a width dimension of the first split component 2A and the second split component 2B in areas without the bolt holes 23 is approximately five mm. When the width dimension of the first split component 2A and the second split component 2B is five mm, if a dimension of the gap between the each of the first mating portions 21A and the each of the second mating portions 21B is equal to or greater than one mm, position tolerance of the mating of the first split component 2A and the second split component 2B can be absorbed. Furthermore, highly accurate positioning is not required. Hence, the feasibility of joining together can be increased. The dimension of the gap between the each of the first mating portions 21A and the each of the second mating portions 21B can be set as appropriate according to the width dimension of the first split component 2A and the second split component 2B.

As illustrated in FIG. 1A, the annular sealing unit 3 formed of an elastic member is fixed along the inner peripheral surface 24 of the core body 2 that has been formed into an annular shape with the first split component 2A and the second split component 2B. As illustrated in FIG. 2A, the sealing unit 3 is fixed to the core body 2 in such a manner as to reach the stepped-down portions 22A of the first split component 2A and the stepped-down portions 22B of the second split component 2B, which prevents the sealing unit 3 from being detached from the core body 2. The sealing unit 3 is a member that deforms elastically and seals the gap between the opposed surface 40 of the first member 4 and the opposed surface 50 of the second member 5. As illustrated in FIG. 2B, an annular protrusion 30 is formed into an annular shape along a circumferential direction of the sealing unit 3 at each end of the sealing unit 3 in a thickness direction thereof. The annular protrusions 30 protrude further outward in the thickness direction than the top surface 200A and the undersurface 201A of the first split component 2A. Similarly, the annular protrusions 30 protrude further outward in the thickness direction than the top surface 200B and the undersurface 201B of the second split component 2B.

As illustrated in FIG. 2A, the annular protrusions 30 have an approximately semicircular shape in vertical cross section in a natural state. A groove portion 31 recessed inward in the thickness direction is annularly formed along each of the annular protrusions 30 and outward of the each of the annular protrusions 30. Moreover, a top surface portion 32 located on an inner peripheral side of the annular protrusion 30 is formed in such a manner as to be located further inward in the thickness direction than the top surface 200A of the first split component 2A and the top surface 200B of the second split component 2B. Similarly, an undersurface portion 33 located on the inner peripheral side of the annular protrusion 30 is formed in such a manner as to be located further inward in the thickness direction than the undersurface 201A of the first split component 2A and the undersurface 201B of the second split component 2B.

As illustrated in FIG. 2B, the gasket 1 is interposed between the opposed surface 40 of the first member 4 and the opposed surface 50 of the second member 5. Therefore, the annular protrusions 30 deform elastically, moving toward the groove portions 31, the top surface portion 32, and the undersurface portion 33. In this manner, the annular protrusions 30 are in a compressed state between the opposed surface 40 of the first member 4 and the opposed surface 50 of the second member 5. As a result, the gap between the opposed surface 40 of the first member 4 and the opposed surface 50 of the second member 5 is sealed.

The elastic member 6 is poured into the gaps between the first mating portions 21A and the second mating portions 21B. The elastic member 6 and the sealing unit 3 are molded and vulcanized by use of the same elastic member. Examples of the elastic member used here include rubber materials such as EPDM, NBR, H-NBR, ACM, AEM, and FKM.

In the gasket 1 according to the embodiment, the first mating portions 21A and the second mating portions 21B, including the edges 21a and 21b, are configured in such a manner as to be inclined relative to the longitudinal direction of the first split component 2A and the second split component 2B in plan view. Hence, the edges 21a and 21b prevent the core body 2 from being bent and deformed, in the longitudinal direction and the width direction, from the first mating portions 21A and the second mating portions 21B. Therefore, the flexural rigidity of the core body 2 against bending in the longitudinal and the width direction improves. Moreover, the mating portions 21A and 21B are formed in such a manner as to be inclined linearly. Hence, it is easy to manufacture the first split component 2A and the second split component 2B. Moreover, highly accurate positioning is not required to mate the first mating portions 21A of the first split component 2A to the second mating portions 21B of the second split component 2B. Furthermore, upon mating, it is also possible to absorb a tolerance.

Moreover, in the embodiment, the one of the first mating portions 21A illustrated in part A of FIG. 1A and the one of the second mating portions 21B illustrated in FIG. 1B, and the other first mating portion 21A illustrated in part B of FIG. 1A and the other second mating portion 21B illustrated in FIG. 1C are inclined in the different directions from each other. Hence, even if the core body 2 attempts to bend from the one of the first mating portions 21A or the one of the second mating portions 21B, the other mating portion 21A or the other second mating portion 21B resists bending in the same direction as the one of the first mating portions 21A or the one of the second mating portions 21B. In other words, even if the core body 2 attempts to bend from the one of the first mating portions 21A, the other second mating portion 21B prevents the core body 2 from bending. Therefore, the flexural rigidity of the core body 2 can be improved as compared to a case where the one of the mating portions 21A and the one of the mating portions 21B and the other mating portion 21A and the other mating portion 21B are inclined in the same direction.

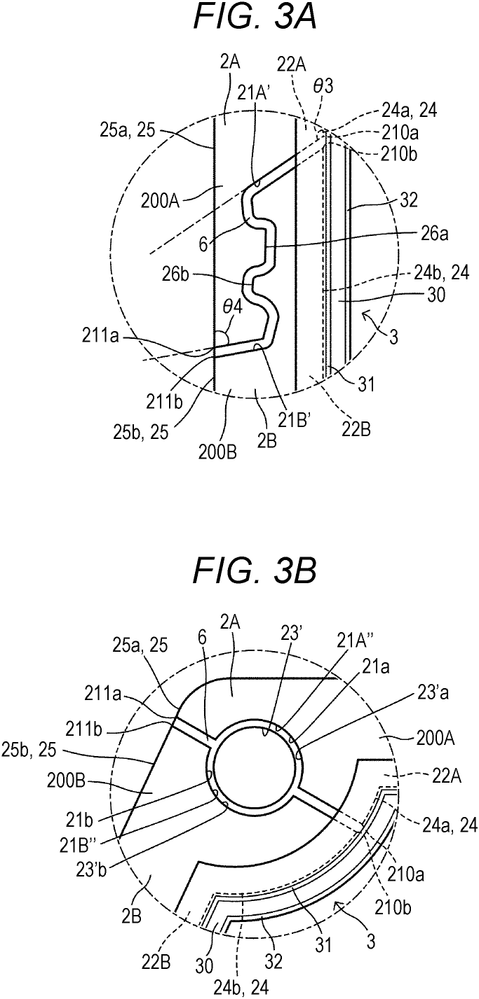

Next, modifications of the first mating portions 21A and the second mating portions 21B are described with reference to FIGS. 3A and 3B. Descriptions of the configurations and effects of common features are omitted.

One of first mating portions 21A′ and one of second mating portions 21B′, which are illustrated in FIG. 3A, are modifications of the one of the first mating portions 21A and the one of the second mating portions 21B, which are illustrated in part A of FIG. 1A and FIG. 1B. The first mating portion 21A′ and the second mating portion 21B′, which are illustrated in FIG. 3A, are formed in such a manner as to include portions that meander in plan view (hereinafter referred to as the “meandering portions”) 26a and 26b. An inner edge 210a of the one of the first mating portions 21A′ is connected to the inner peripheral surface 24a of the first split component 2A. Moreover, the edge 210a is inclined at an angle θ3 relative to the longitudinal direction of the first split component 2A in plan view in such a manner as not to be parallel to and perpendicular to the longitudinal direction. An outer edge 211a of the one of the first mating portions 21A′ is connected to the outer peripheral surface 25a of the first split component 2A. Moreover, the edge 211a is inclined at an angle θ4 different from θ3 relative to the longitudinal direction of the first split component 2A in plan view in such a manner as not to be parallel to and perpendicular to the longitudinal direction. The inner edge 210a and the outer edge 211a are formed at different positions in the longitudinal direction of the first split component 2A. The inner edge 210a and the outer edge 211a are linked by the meandering portion 26a. The meandering portion 26a is formed in such a manner as to extend in the longitudinal direction of the first split component 2A. In the modification, a plurality of protrusions and recesses is formed in a width direction of the first split component 2A. An inner edge 210b, the meandering portion 26b, and an outer edge 211b are formed in such a manner that a gap of a predetermined spacing is formed between the one of the second mating portions 21B′ that faces the one of the first mating portions 21A′, and the one of the first mating portions 21A′ when the two mating portions are mated together. The first mating portions 21A′ and the second mating portions 21B′ are joined by an elastic member. As a result, the annular core body 2 is formed.

The first mating portion 21A′ and the second mating portion 21B′ of the modification are modifications of the one of the first mating portions 21A and the one of the second mating portions 21B, which are illustrated in part A of FIG. 1A and FIG. 1B. The first mating portion 21A′ and the second mating portion 21B are formed in such a manner as to include the meandering portions 26a and 26b, which makes the core body 2 resistant to bending from the first mating portions 21A′ or the second mating portions 21B′. Hence, it is possible to encourage a further improvement in the flexural rigidity of the core body 2. The other first mating portion 21A and the other second mating portion 21B, which are illustrated in part B of FIG. 1A and FIG. 1C, may also be similarly formed in such a manner as to include the meandering portions 26a and 26b. In this case, the angle of inclination of the other inner edges 210a and 210b connected to the inner peripheral surface 24 of the core body 2, and the angle of inclination of the other outer edges 211a and 211b connected to the outer peripheral surface 25 of the core body 2 are desirably different from both of the angles of inclination θ3 and θ4 illustrated in FIG. 3A. In other words, the edges have different angles of inclination from those of the remaining edges, which makes the core body 2 resistant to bending deformation that starts from each mating portion. Hence, it is possible to encourage a further improvement in the flexural rigidity of the core body 2.

Next, a modification of FIG. 3B is described.

A bolt hole 23′ illustrated in FIG. 3B is a modification of the bolt hole 23 illustrated in part C of FIG. 1A. The bolt hole 23′ of FIG. 3B is formed by a first mating portion 21A″ and a second mating portion 21B″ that are joined together by an elastic member. Both of the mating portions are mated together in such a manner as to have a gap between an end of the first split component 2A and an end of the second split component 2B. The first mating portion 21A″ and the second mating portion 21B″ are configured in such a manner as to include semicircular recesses 23′a and 23′b, respectively. Moreover, the circular bolt hole 23′ is formed along edges of the recesses 23′a and 23′b by use of the fixed elastic member. In the first mating portion 21A″, the inner edge 210a connected to the inner peripheral surface 24a of the first split component 2A, and the outer edge 211a connected to the outer peripheral surface 25a of the first split component 2A are configured in such a manner as to have approximately the same angle of inclination and be located on substantially the same line. The inner edge 210b and the outer edge 211b of the second mating portion 21B″ are also configured in such a manner as to have approximately the same angle of inclination and be located on substantially the same line. In this manner, a gap of a predetermined spacing is formed between the inner edge 210a of the first mating portion 21A″ and the inner edge 210b of the second mating portion 21B″. Similarly, a gap of the predetermined spacing is formed between the outer edge 211a of the first mating portion 21A″ and the outer edge 211b of the second mating portion 21B″. In the gasket 1 including the bolt hole of the modification (the gasket 1 of the modification), mating portions are not formed in an area corresponding to part A of FIG. 1A. The other configuration of the gasket 1 of the modification is substantially the same as the first embodiment.

In the gasket 1 of the modification, the bolt hole 23 other than the bolt hole 23′ formed by the first mating portion 21A″, the second mating portion 21B″, and the elastic member has a configuration similar to the first embodiment. The bolt hole 23′ has flexibility due to the elastic member. Hence, when the gasket 1 of the modification is assembled to the first member 4 and the second member 5, the bolt hole 23′ illustrated in FIG. 3B can absorb variations in the positions of the other bolt holes 23. Hence, the ease of assembly can be improved. In the modification, the position where the other first mating portion 21A and the other second mating portion 21B are provided is not limited to the position illustrated in part B of FIG. 1A, or FIG. 1C. Any of the bolt holes 23 illustrated in FIG. 1A may be formed by the first mating portion 21A″ including the recess 23′a, and the second mating portion 21B″ including the recess 23′b. In this case, the inner edges 210a and 210b are desirably formed in such a manner as to have different angles from the angle of inclination θ3 illustrated in FIG. 3A and be inclined in different directions. Moreover, the outer edges 211a and 211b are desirably formed in such a manner as to have different angles of inclination from the angle of inclination θ4 illustrated in FIG. 3A, and be inclined in different directions.

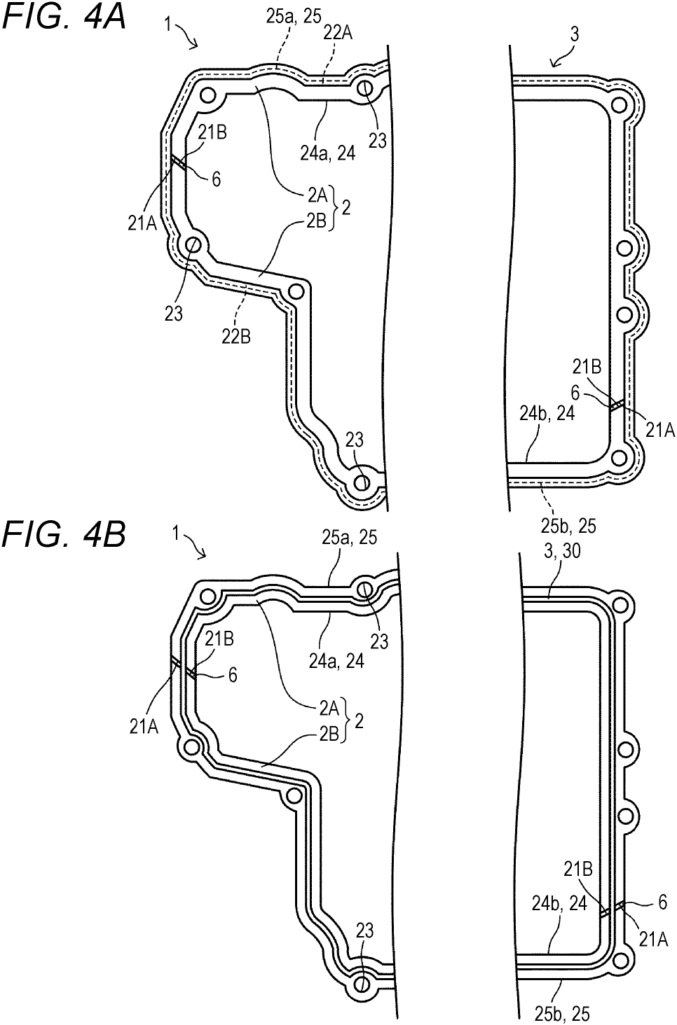

Moreover, the configuration of the sealing unit 3 is not limited to the structure of the sealing unit 3 used in the first embodiment illustrated in FIGS. 1A to 1C and FIGS. 2A and 2B, either. For example, the sealing unit 3 may be formed into an annular shape in such a manner as to be fixed to the outer peripheral surface 25 of the core body 2 as illustrated in FIG. 4A. In this case, the stepped-down portion 22A is provided on the outer peripheral surface 25a side of the top surface 200A of the first split component 2A in such a manner that the outer peripheral surface 25a side is cut inward in the thickness direction of the first split component 2A. Similarly, the stepped-down portion 22B is provided on the outer peripheral surface 25b side of the top surface 200B of the second split component 2B in such a manner that the outer peripheral surface 25b side is cut inward in the thickness direction of the second split component 2B.

Moreover, the annular sealing unit 3 may be formed in such a manner as to pass through approximately the center in the width direction of the first split component 2A and the second split component 2B as illustrated in FIG. 4B. Also in this case, the annular protrusions 30 that protrude further than the top surface 200A and the undersurface 201A of the first split component 2A are formed. Moreover, the annular protrusions 30 that protrude further than the top surface 200B and the undersurface 201B of the second split component 2B are formed.

The configuration of the gasket 1 is limited to neither the above-mentioned configuration nor the illustrated configuration. For example, the first split component 2A and the second split component 2B are not limited to components formed by stamping a metal sheet. Moreover, the first split component 2A and the second split component 2B may be formed of not a metal material but a rigid resin material. Moreover, the number of split components forming the core body 2 is not limited to two, either. The core body 2 may include three or more split components. Moreover, one end of the first split component 2A in the longitudinal direction and one end of the second split component 2B in the longitudinal direction may form the first mating portion 21A and the second mating portion 21B via a gap, whereas the other end of the first split component 2A in the longitudinal direction and the other end of the second split component 2B in the longitudinal direction may not be in contact with each other. In this case, the other end of the first split component 2A in the longitudinal direction and the other end of the second split component 2B in the longitudinal direction are not configured as mating portions.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An annular gasket for sealing a gap between opposed surfaces of two members, the gasket comprising:
a core body including a plurality of split components;
a sealing unit fixed to the core body; and
an elastic member, wherein
ends of the plurality of split components are mated together in such a manner as to have a gap between the ends,
the ends mated together are joined by the elastic member, and
edges of the joined ends are inclined relative to a longitudinal direction of the split components in plan view.

2. The gasket according to claim 1, wherein the ends, including the edges, are inclined linearly relative to the longitudinal direction.

3. The gasket according to claim 2, wherein a plurality of the ends is inclined in directions different from each other relative to the longitudinal direction.

4. The gasket according to claim 1, wherein the ends form a meandering portion.

5. The gasket according to claim 1, wherein
the core body includes a plurality of bolt holes through each of which a bolt for fastening the two members together is inserted, and
at least one of the bolt holes is provided to the ends.
